(19) United States
(12) Patent Application Publication
(10) Pub. No.: US 2018/0197133 A1
(43) Pub. Date: Jul. 12, 2018

(54) COMPUTERIZED AUTOMATIC INVENTORY ALERT AND MANAGEMENT

(71) Applicants: Cheryl L. Linke, Graham, WA (US); Victoria Laverty, Graham, WA (US)

(72) Inventors: Cheryl L. Linke, Graham, WA (US); Victoria Laverty, Graham, WA (US)

(21) Appl. No.: 15/400,932

(22) Filed: Jan. 6, 2017

(51) Int. Cl. G06Q 10/08; G06F 17/30; G06Q 50/22

(52) U.S. Cl. CPC G06Q 10/087; G06Q 50/22; G06F 17/30377

(57) ABSTRACT

A method and a device are disclosed including a computer system, a barcode scanner, a database, and inventory monitoring, ordering, and alert software components to create an Inventory Management System (IMS). The IMS may track inventory as supplied and consumed and issue alerts via a user interface to operators. The IMS may further issue purchase orders automatically to replenish inventory items when the levels fall below a predefined threshold. In some embodiments, the IMS may be implemented as a distributed system including multiple IMS Agents (IMSA), one at each branch facility of an organization. In some embodiments, the Distributed IMS (DIMS) may generate statistical data and profiles of various branches of the organization to predict what inventory levels of each item to order for each branch for physical storage and minimize inter-branch supply transfers.

### CROSS-REFERENCE(S) TO RELATED APPLICATION(S)

None.

### TECHNICAL FIELD

This application relates generally to product and supplies inventory management. More specifically, this application relates to a computer system to alert operators in a service facility that specific products or supplies are close to expiration and automatically place orders to replenish the supplies.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example computer-based Inventory Management System (IMS);

FIG. 4 shows an example color-coded inventory alert interface to notify human operators of status and shortage of inventory items;

FIG. 5 shows an example multi-facility IMS;

FIG. 6 shows an example flow diagram for inventory ordering; and

FIG. 7 shows an example flow diagram for inventory transfer between different facilities in a multi-facility IMS.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular facilities like hospitals and clinics, it will be appreciated that the disclosure may be used with other types of large service facilities, such as universities, schools, government offices, chemical plants, manufacturing plants, department stores, supermarkets and grocers, cafeterias and restaurants, and the like.

Briefly described, an Inventory Management System (IMS) and a method are disclosed including a computer system, a barcode scanner, and inventory monitoring, ordering, and alert software components integrated with the computer system. The IMS may also include a database management system that holds inventory data for various products, supplies and items. The IMS may track inventory as supplied and consumed and issue alerts via a user interface to operators about low inventory levels. The IMS may further issue purchase orders automatically to replenish inventory items when the levels fall below a predefined threshold. In some embodiments, the IMS may be implemented as a distributed system including multiple IMS Agents (IMSA), one at each branch facility of an organization, to share a common database of inventory and automatically transfer surplus items between the branches to maximize the utilization of inventory items across the whole organization. In some embodiments, the Distributed IMS (DIMS) may generate statistical data and profiles of various branches of the organization to predict what inventory levels of each item to order for each branch for physical storage and minimize inter-branch supply transfers.

Most facilities and organizations, especially large public ones, such as hospitals and law offices, have many items that they keep in inventory for daily use and consumption. For example, hospitals have many sizes of sterile pads and gauzes, common cleaning and disinfecting compounds, and other medical supplies that are used daily to treat patients. Keeping a predictable and steady supply of such items may often be an important part of the services offered by the organization and the management and cost control of these facilities. The Health Insurance Portability and Accountability Act (HIPAA) of 1996 compliance rules and other privacy rules and laws may also affect how supplies are managed.

To maintain or improve the quality of services in a facility and also to maintain or reduce the cost of supplies and inventoried items, it is desirable to automate and computerize the management of supplies and inventories to make the process more efficient, speedy, and cost-effective.

### Illustrative Operating Environment

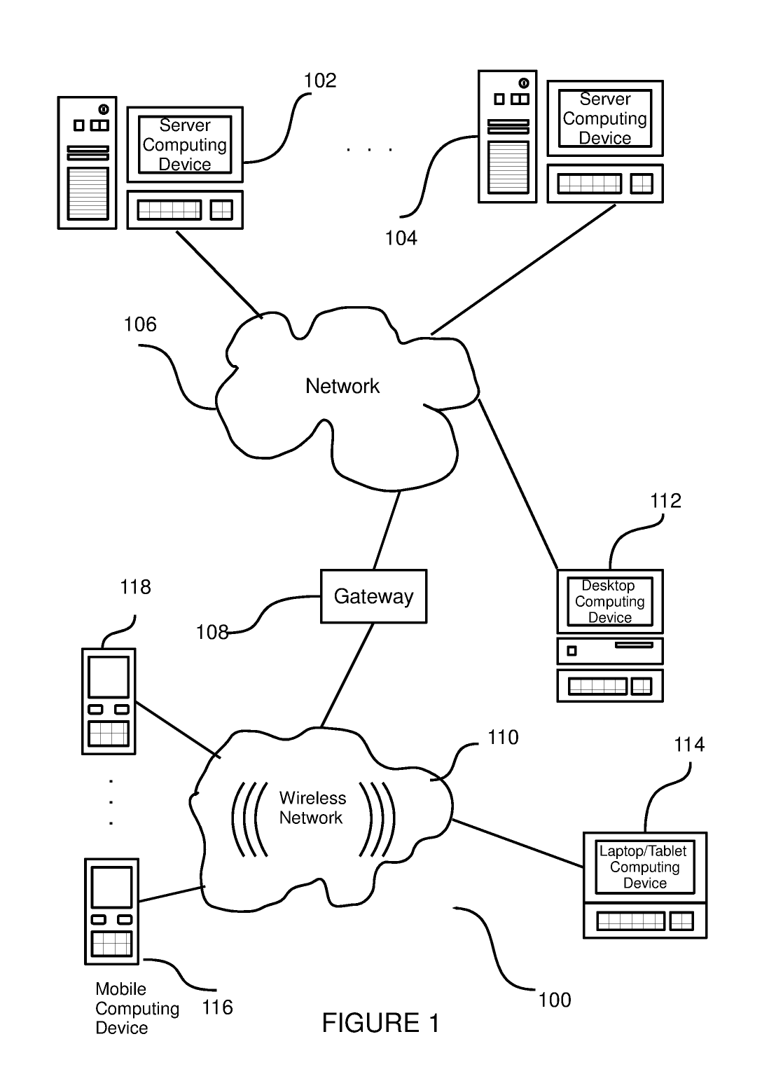

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

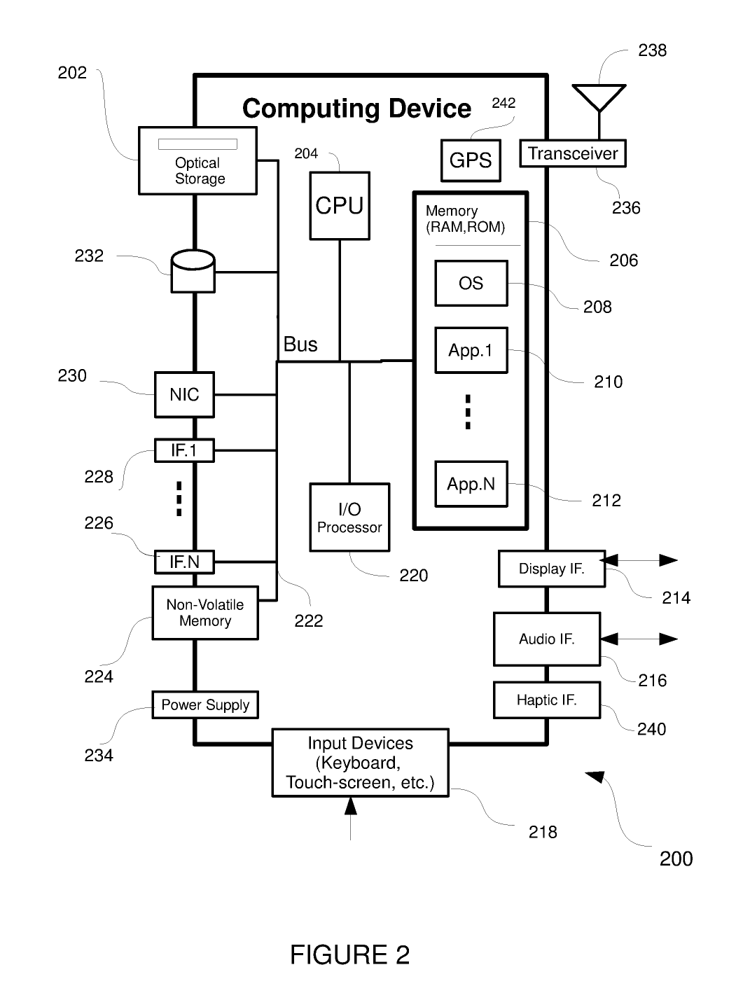

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, Bluetooth Low Energy (LE), High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC (Media Access Control) address.

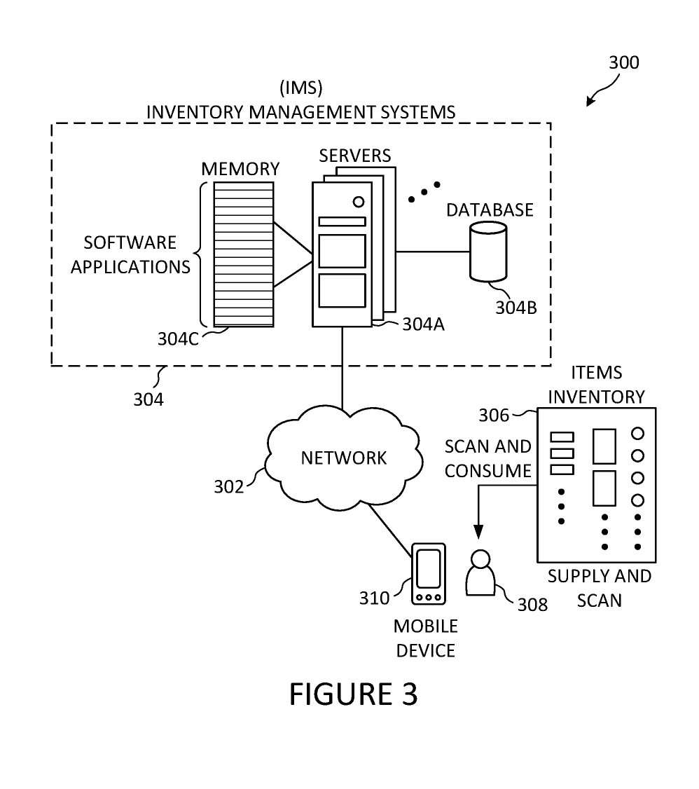

FIG. 3 shows an example computer-based Inventory Management System (IMS). In various embodiments, the IMS environment 300 includes a computer network 302, an IMS 304 coupled with the computer network and having a set of servers 304A with memory 304C to hold software applications for execution, and a database 304B. A physical items inventory 306 may be used by operator 308 to supply and consume items and update IMS via a mobile device 310.

In various embodiments, the IMS computer system manages the items inventory 306 of an organization such as a hospital, a university, a school, a government office, a chemical plant, a manufacturing plant, a department store, a supermarket or grocer, a cafeteria or restaurant, and the like. In basic operation, the items in physical inventory 306 are scanned and saved in the database 304B. The database is updated as new items are placed in the inventory and existing items are consumed.

In various embodiments, the IMS may issue alerts to the operator 308, for example, a nurse in a hospital, when the inventory for an item is low. The alert may be in the form of a change in a cell color, flashing cell, or placement of icons on a spreadsheet, such as Microsoft's Excel®, a text message, an email, or other special alerts that draws attention to the status of the inventory of an item. For example, if the nurse uses four medical pads out of the inventory causing the quantity of the medical pads to drop below a threshold or par level for the pads, then an alert is issued by the IMS to the nurse and anybody else who may check the inventory. The IMS may further place an order automatically to replenish the quantity of the medical pads. In some embodiments, a margin may be added to the threshold on either the lower or higher side before an action is triggered. For example, if the threshold or par value for an item such as a 3″×3″ sterile pad is 20, then a margin of +3 (that is, 20+3=23) and −4 (that is, 20−4=16) combined with the threshold creates an action threshold. So, if the number of pads fall below 23, say 21, then even though it is still above 20, then an alert may be issued. Similarly, once the number of pads drops to 16 then a purchase order may be issued. Such margins allow a more stable system so that immediate actions are not taken every time the threshold is crossed in either direction.

In various embodiments, with continued reference to FIG. 3, as items are placed into the physical inventory 306, they are scanned using a scanning device (not shown) in communication with the mobile computing device 310 and entered into the database via computer network 302 and server 304A. Similarly, as items are consumed from the inventory they may be scanned by the operator who takes the items and the database is updated accordingly to reflect the state of the physical inventory. The scan may be a barcode scan, an OCR (Optical Character Recognition) scan to read and register an alphanumeric code, or any other type of scan that can identify and record the scanned item. So, for example, if 10 new sterile pads are received at the inventory, they are scanned and the database is updated to show the number of pads has increased by 10.

As the database is updated, the inventory list, for example, an Excel spreadsheet, may be updated also, not just to show the numbers but also to adjust the display, turn off alarms, change cell colors, update any expiration dates of perishable items (or just items with designated expiration dates). The database may include inventory data tables that have information similar to the spreadsheet. The database table may be occasionally copied onto the spreadsheet for presentation to the user by a software interface module. This module may add further information, such as alerts in the form of colors and other visual indicators, to the spreadsheet for presentation.

In various embodiments, the IMS may be implemented by a hardware and/or software system using one or more software components executing on the illustrative computing device of FIG. 2. One or more functions may be performed by each software module recorded on a medium such as an optical disk, magnetic tape, volatile or non-volatile computer memory, and the like, or transmitted by various communication techniques using various network and/or communication protocols, as described above with respect to FIG. 1. For example one or more separate software components may be used for each of the functions in the system such as a software scanning module that receives scanning data from a scanning device associated with the IMS inventory, a software threshold evaluation module, a software interface module that presents inventory data to users and operators including any colored or flashing alerts signifying the shortage of an inventory item or other indicators such as purchase order issuance, a software configuration module to set the item thresholds and/or threshold margins, alert colors, and the like, a software order or purchase module to automatically issue purchase orders to replenish depleted supply of inventory items, an inventory transfer module to initiate transfer of overstocked items from one facility to another for balanced distribution of the overstocked items, a database interface module to update the database based on supply and consumption of inventory items, and other software modules as appropriate. Those skilled in the art will appreciate that one function may be implemented using multiple software modules or several functions may be implemented using one software module. With further reference to FIG. 2, these software modules are generally loaded into the memory module 206 of the computing device for execution.

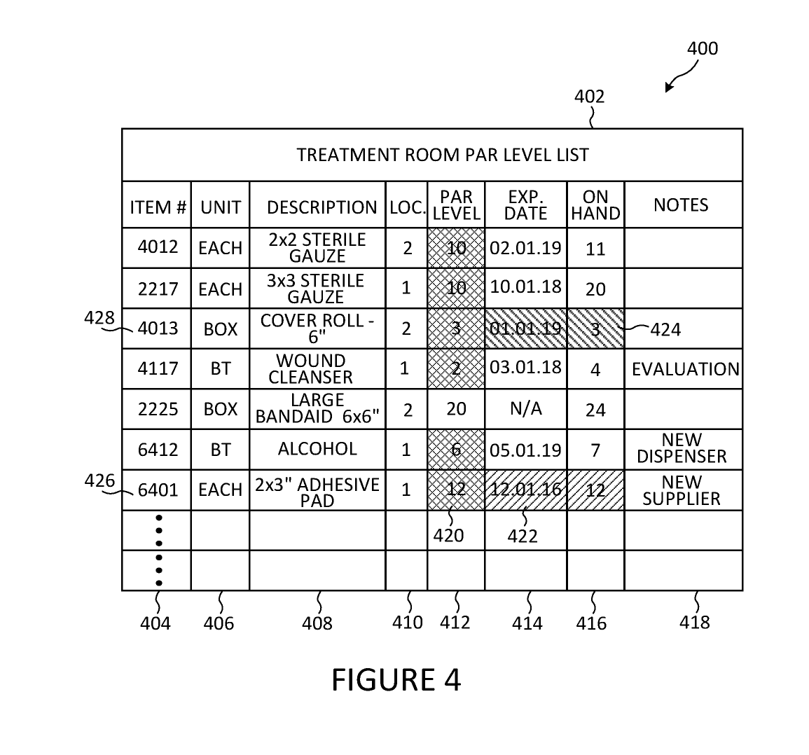

In various embodiments, in operation, the various software modules interact with each other to perform various functions. For example, the software scanner module may receive and store item information from a scanning device in the database using the software database interface module. The software threshold evaluation module may take the scanning data and other inventory information (See FIG. 4) from the database, via the software database interface module, and ascertain whether actual item numbers exceed respective thresholds. The software threshold evaluation module may then call the software interface module to update the user interface with alert information. It may also call the software purchase order module to place orders as needed. In some embodiments, the database is a common memory used by all software modules involved for indirect communications. One software module may store a particular information in the database, while others read the same information to make other decisions as appropriate. This way, the database behaves like a common communication memory.

FIG. 4 shows an example color-coded inventory alert interface to notify human operators of status and shortage of inventory items. In various embodiments, a user interface such as a spreadsheet 400 may be used to display a list of items inventory including a header or title 402, a column 404 for item reference number, column 406 for unit of quantity of inventory items, column 408 showing a description of the items, column 410 listing a facility location identifier or code, column 412 showing the threshold or par level of the items, column 414 showing the expiration dates for the inventory items as applicable, column 416 showing the actual quantity of items on hand, and column 418 for creating any notes for each item. Rows 426 and 428 may have colored or shaded spreadsheet cells 420, 422, and 424 to draw attention to special events.

In various embodiments, the inventory list presented to users may be a spreadsheet like Excel that is updated by the software interface module to alert the operators or users of impending shortage of one or more items. With continued reference to FIG. 4 and as an illustrative example, row 426 may have colored, shaded, or flashing cells 422 to draw the user's attention to a critical status of an item such as 2″×3″ Adhesive Pads with par level of 12 and inventory on hand of 12. The colored cell 422 may indicate a low level of this item and/or an expired or approaching expiration date. Similarly, row 428 may indicate such an event. In this example, a medical treatment room setting is considered. Listed are some medical supplies that are used by state, and federal hospitals. This setting may also be applicable to any stockroom, any food storage inventory, and home storage with known expiration dates of items in a freezer and/or a refrigerator. Facilities, such as hospitals that get government funding and must remain compliant with government guidelines may especially benefit from IMS.

In some embodiments, the user interface may have pages set up as tabs that are color-coded for quick visual identification and fewer operator errors. Items that have an expiration date may be highlighted with a color, such as goldenrod. Continuing with this example, the treatment room par level column 412 shows the number of items that should be maintained in the inventory. Column 414 shows the date of expiration for the item in each row. Row 426 shows with 2″×3″ pads that has a par level of 12. The cell for this row under column 412 (Par Level) is shown as shaded (or color in a real application) signifying that this is an item that is due to expire at some time. The Expiration Date (col. 414) and On-hand (col. 416) columns may be shaded or colored (either background or the text or both) to indicate this item is close to expiration.

Continuing with this example, the row with item number of 2225 (Large Bandaid) has no expiration date and thus the cell in this row and under column 412 is not colored or shaded, visually indicating that this item has no expiration date. On row 428, the Date column 414 and On-hand column 416 are shown as shaded (or colored background and or text, for example, in pink background and yellow lettering) indicating an alarm issued to call attention to the status of the item in this row as expiring in the month indicated.

In various embodiments, The IMS software interface module may change the colors of the cells in the inventory list to indicate the changing status of items. For example, a cell color may change from yellow to the pink with red numbers, as time passes or calendar progresses, to keep the operator or users appraised of the dates and items ready to expire in the inventory. Such automatic alerts and/or ordering of new items may reduce the cost of inventory management in various facilities, such as hospitals, that may be legally penalized for having or using expired products. IMS, through the use of computer automation and database, may improve the cost and quality of inventory maintenance, and may also be useful to prove a facility is compliant with regulations in case of a government audit.

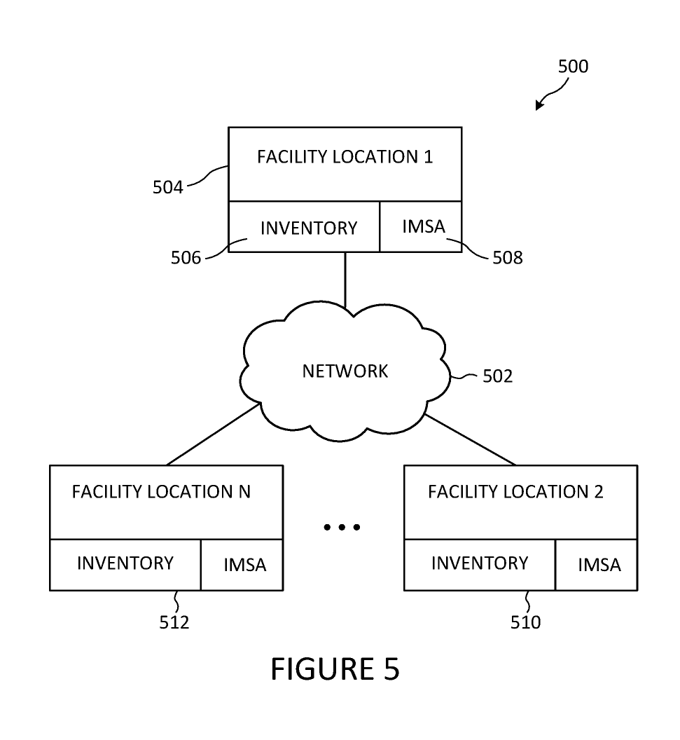

FIG. 5 shows an example multi-facility IMS. In various embodiments, a multi-facility organization 500 may include several geographically separated facilities 504, 510, and 512, each having a physical inventory 506 and an IMS Agent (IMSA) software application in communication with the IMS for the overall organization via a computer network 502.

In various embodiments, a Distributed IMS (DIMS) may be used having an IMSA in each facility to communicate with other IMSAs in other facilities to coordinate the transfer of excess inventory from one facility to another facility with a deficit in a particular item. For example, if facility at location 2 has 50 size 2″×3″ sterile pads with a par level of 30, then some of the excess 20 pads may be transferred to another facility having only 20 sterile pads on hand.

In some embodiments, the DIMS may be implemented as a collection of IMSAs in communication with each other to update a common database and maintain their respective physical inventories in compliance with various applicable regulations or rules, if any. In such a distributed system with distributed monitoring and control, a central database may be accessible by all IMSAs to monitor and update. This way all IMSAs know at all times what inventory their respective facilities have and whether any transfer of inventory items may be needed. If an IMSA discovers that it is short of an item or getting close to expiration dates of some items, then it can look up in the database to see if other facilities have excess inventory of the short or scarce items, in which case the short IMSA can request another one or more IMSA with excess inventory of the same item or items to transfer some or all of the excess to the short IMSA. Otherwise, the IMSA can order more of the short items from external suppliers, distinct from other facilities within its organization.

In other embodiments, a central IMS and database may be located at a designated facility and other facilities may have subordinate IMSAs that are in communication with the IMS. In such embodiments, the local IMSAs for each facility may only report on local inventories to the IMS, which will update the central database and determine whether short items need to be transferred to other facilities from facilities with excess inventory or to order such items externally. This decision may be based on various programmed computer rules created by an administrator via the software setup module for the IMS, or it may be imposed by the administrator on the IMS on a case-by-case basis.

In some embodiments, the IMS and/or respective IMSAs at various facilities within an organization may generate and update a facility inventory profile to predict what and how many of each item the facility may need to avoid over- or under-ordering of various items. For example, each IMSA can track the monthly consumption of an item, such as a 2″×3″ Sterile Pad at a hospital and update the hospital's profile in the database with respect to this item. When time comes to order more, the IMS can order or assist in ordering an optimal number of such pads for the hospital to avoid over- or under-stocking of the item. The profile is generally dynamic because the consumption of an item may vary over time, seasonally, or as new treatments and alternatives become available, possibly replacing an existing item. The organization may include a hospital or medical clinics chain, a university campus, a governmental department, a school district, a manufacturer of goods with multiple facilities, or any other organization with multiple facilities that maintains a physical inventory of goods for its use and consumption.

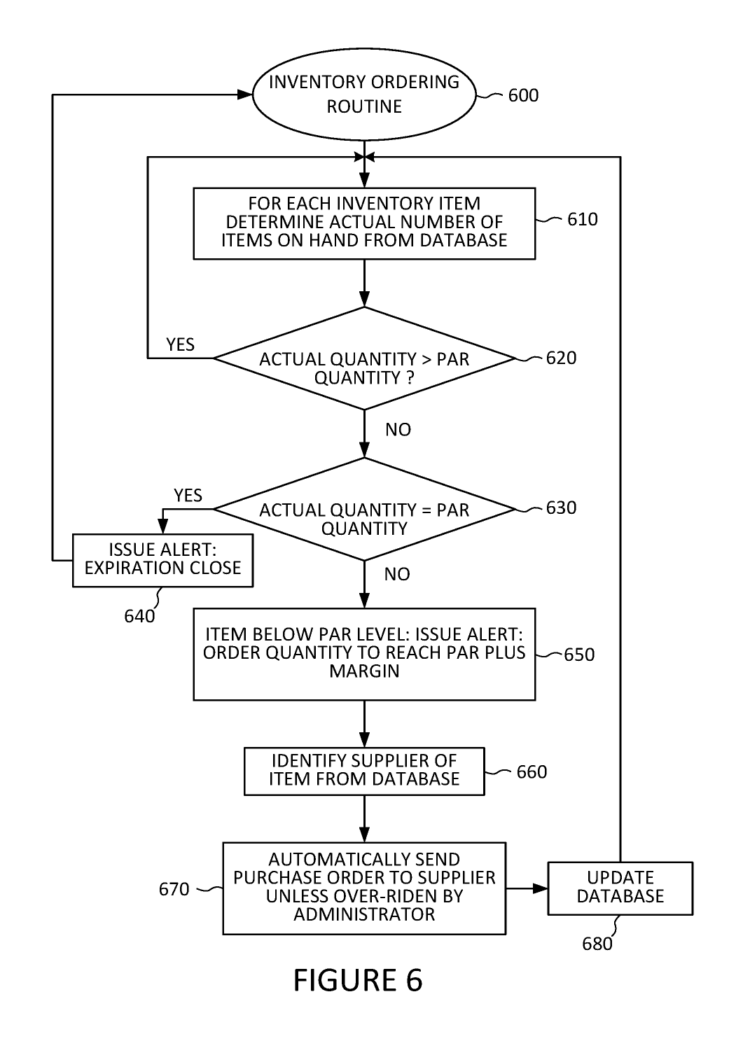

FIG. 6 shows an example flow diagram for inventory ordering. In various embodiments, with reference to FIGS. 3, 5, and 6, inventory ordering routine 600 proceeds to block 610 in which it is determined for each inventory item the actual number of items on hand from the database. The routine proceeds to decision block 620.

At decision block 620, it is ascertained whether the actual quantity of an item on hand is greater than the par level or minimum required quantity in stock. In some embodiments, the par level may be added to a margin before this comparison is made. So, if the par level is 20 and the margin is 4, then the quantity on hand may be compared with 20+4=24, rather than 20. This way, the system behavior will be smoother and less thrashing occurs (erratic behavior) by reacting and changing inventory everytime the par level threshold is crossed in either direction. In effect, the margin behaves like a yellow traffic signal light, preparing the drivers ahead of the time they need to take action, thus making traffic smoother. This comparison with boundary may also occur with expiration date, not just quantity of items. So, the expiration date of the items in inventory (FIG. 4, column 414) may be compared with the current date to see how close it is to expiration. Again, a date margin may be applied to avoid thrashing, the margin being a few extra days added to the current date. If actual quantity is greater than the par level (or par plus margin), then the routine proceeds back to block 610, otherwise, it will proceed to decision block 630.

At decision block 630, it is ascertained whether the actual quantity on hand is equal to the par quantity (or par plus margin). If it is, the routine proceeds to block 640, otherwise it will proceed to block 650.

At block 640, an alert may be issued by the IMS that the actual quantity is close to falling below the par level. The alert may also be issued for expiration date (or expiration date plus a time margin) instead or in addition to the threshold quantity. The alert may be in the form of a visual indicator such as change of color of a cell in a spreadsheet like Excel, a flashing color, change of text and/or background color, a beep sound, a text message, an email, or any other way of user notification, or a combination of the above. The colors or other visual indicators may be become progressively more vivid and draw more attention as the required threshold (quantity or time) approaches. For example, as the quantity approaches the par level from a par-plus-margin level, the color of the cell may change from light pink to bright pink to red. The routine proceeds back to block 610 after issuing the alert.

At block 650, the item quantity has fallen below the threshold (par value). At this time, another alert may be issued to indicate that the quantity on hand is now below the required threshold (or that the expiration date has been reached or passed). Furthermore, a purchase order may be prepared automatically by the IMS, unless overridden by an administrator, in preperation to externally purchase and supply an item to the inventory to replenish any shortages. The IMS may also update the database to indicate the order status of an item to prevent over-ordering or over-stocking items. The routine proceeds to block 660.

At block 660, the identity of the one or more suppliers is determined from the database for a given short item. The routine proceeds to block 670.

At block 670, the purchase order prepared before is issued and sent to the identified supplier(s) for delivery of short items. The routine proceeds to block 680.

At block 680, the database is updated to reflect the new status of items after ordering or after issuing alerts. The routine goes back to block 610.

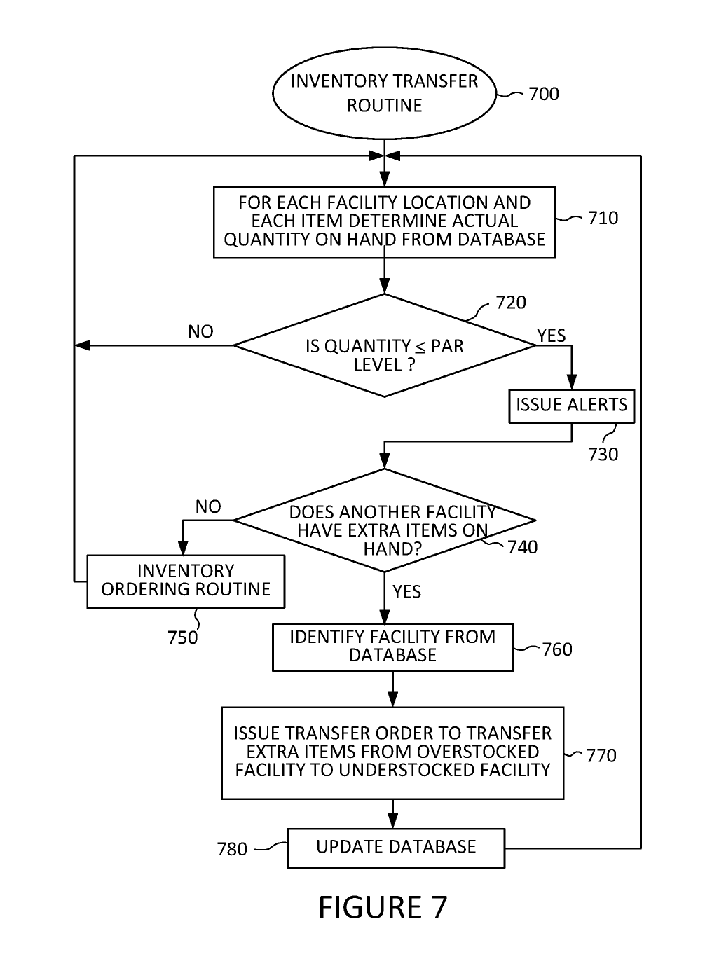

FIG. 7 shows an example flow diagram for inventory transfer between different facilities in a multi-facility IMS. In various embodiments, the inventory transfer routine 700 proceeds to block 710.

At block 710, for each facility location and each item the number of the items on hand (actual number) is determined from the database. The routine proceeds to decision block 720.

At decision block 720, the actual quantity is compared with the respective par level. ?? In some embodiments, the par level may be added to a margin before this comparison is made. So, if the par level is 20 and the margin is 4, then the quantity on hand may be compared with 20+4=24, rather than 20. This way, the system behavior will be smoother. This comparison with boundary may also occur with expiration date. So, the expiration date of the items in inventory (FIG. 4, column 414) may be compared with the current date to see how close it is to expiration. A date margin may be applied to avoid thrashing, the margin being a few extra days added to the current date. If actual quantity is not less than or equal the par level (or par level plus a margin), then the routine proceeds back to block 710. Otherwise, the routine proceeds to block 730.

At block 730, an alert is issued because the actual number of one or more items is found to be less than or equal par level. The alert may also be issued for expiration date (or expiration date plus a time margin) instead or in addition to the threshold quantity. The alert may be in the form of a visual indicator such as change of color of a cell in a spreadsheet like Excel, a flashing color, change of text and/or background color, a beep sound, a text message, an email, or any other way of user notification, or a combination of the above. The colors or other visual indicators may be become progressively more vivid and draw more attention as the required threshold (quantity or time) approaches. For example, as the quantity approaches the par level from a par-plus-margin level, the color of the cell may change from light pink to bright pink to red. Next, the routine proceeds to decision block 740.

At decision block 740, the IMS may determine if another facility within the organization has excess quantities of the short items. This may be done by looking at total quantities of the short items across all facilities within the organization to quickly ascertain whether excess quantities are available at one or more facilities. In one embodiment, this may be done by determining the total of par levels of the same item across all facilities and comparing with the actual numbers on hand of the same item across all facilities. If the total actual number is greater than the total par levels, then there is an excess of that item in the organization. If no excess quantities are found of the target item within the organization, then the routine will invoke the Inventory Ordering Routine of FIG. 6. Otherwise, the routine will proceed to Block 760.

At block 760, specific facilities with excess quantities of a short item are found by examining the database. When one or more facilities are identified that have sufficient excess quantities, then IMS will be ready for transfer of excess items to the facilities that need them. The routine then proceeds to block 770.

At block 770, the IMS may issue a transfer order, possibly subject to approval or rejection of administrators, from facilities with excess quantities of a short item to the facilities that are short of the same item. The routine proceeds to block 780.

At block 780, the database is updated to reflect the new status of items after ordering or after issuing alerts. The routine goes back to block 710.

It will be understood that each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. An Inventory Management System (IMS) comprising:
a server computing system having a processor and a memory;
a database coupled with the server computing system;
an inventory list to maintain an updated list of inventory items;
a software threshold evaluation module to run on the processor to determine whether an inventory item quantity threshold is crossed; and
a software interface module to run on the processor to display updated information about the inventory items.

2. The IMS of claim 1, further comprising a computer network over which a scanning device transmits data to the server computing device via a mobile computing device.

3. The IMS of claim 1, wherein the inventory items are medical supplies.

4. The IMS of claim 1, wherein the database includes an inventory table having an item identification number column, an item actual quantity column, and an item threshold level column.

5. The IMS of claim 1, wherein the inventory list comprises a spreadsheet.

6. The IMS of claim 1, wherein the inventory list is updated by copying an inventory table from the database onto the inventory list.

7. The IMS of claim 1, wherein the software threshold evaluation module communicates with software scanning module using the database.

8. The IMS of claim 1, wherein the software interface module communicates with the software threshold evaluation module to determine what information to display, the information including visual color-coded alert notifications in a spreadsheet.

9. A method of managing physical inventory, the method comprising:
accessing a database coupled with a server computing device;
reading an actual quantity of an inventory item;
reading a par level quantity of the inventory item;
comparing the actual quantity and the par level quantity;
issuing an alert if the actual quantity is below the par level quantity; and
displaying the alert in the form of a change of color in a spreadsheet cell.

10. The method of claim 9, further comprising scanning inventory items as they are added to or removed from a physical inventory.

11. The method of claim 9, further comprising updating the database as inventory items are added to and consumed from a physical inventory.

12. The method of claim 9, wherein inventory items are scanned by a scanning device coupled with a mobile computing device and transmitted to the server computing device for updating the database.

13. The method of claim 9, wherein inventory data from the database are copied to the spreadsheet for display to users.

14. The method of claim 9, wherein the inventory item is a medical supply.

15. A Distributed Inventory Management System (DIMS) comprising:
a plurality of facilities belonging to one organization, each of the plurality of the facilities having a server computing device and an Inventory Management System Agent (IMSA);
a computer network coupling the plurality of the facilities; and
a database coupled with each of the server computing devices of the plurality of facilities, wherein each of the IMSAs determines a shortage of inventory items in its respective facility using database information and arranges for a transfer of short items in its inventory from other facilities that have an over-stock of the same short items.

16. The DIMS of claim 15, wherein the IMSAs use a single common database to communicate information.

17. The DIMS of claim 15, wherein the DIMS includes a central Inventory Management System (IMS) that communicates with and coordinates all IMSAs.

18. The DIMS of claim 15, wherein the organization to which the plurality of facilities belong includes one of a hospital chain, a school district, a governmental department, and a manufacturer of goods.

19. The DIMS of claim 15, wherein an IMSA of a facility that is short of a particular inventory item checks the total inventory across all of the plurality of facilities for the particular short item and if sufficient numbers of the particular short item are not on hand at any of the plurality of facilities, then issues a purchase order from an external supplier to supply the short item.

20. The DIMS of claim 15, wherein each IMSA updates the database with information from its respective facility's inventory.
